(19) United States
(12) Patent Application Publication
(10) Pub. No.: US 2023/0000164 A1
(43) Pub. Date: Jan. 5, 2023

(54) Aerosol Generating Device with Non-Linear Airflow Channels

(71) Applicant: JT International SA, Geneva (CH)

(72) Inventor: Alec Wright, Guildford (GB)

(73) Assignee: JT International SA, Geneva (CH)

(21) Appl. No.: 17/782,349

(22) PCT Filed: Dec. 3, 2020
(86) PCT No.: PCT/EP2020/084502

§ 371 Date: Jun. 3, 2022

(30) Foreign Application Priority Data
Dec. 5, 2019 (EP) 19213820.4

(51) Int. Cl. A24F 40/48; A24F 40/46; A24F 40/50

(52) U.S. Cl. CPC A24F 40/48; A24F 40/46; A24F 40/50

(57) ABSTRACT

The present invention is generally directed towards an aerosol generating device. More specifically, the invention is directed towards an aerosol generating device comprising an air flow channeling assembly with non-linear air flow channels. In a first aspect, the invention provides an aerosol generating device comprising a chamber configured to receive and supply heated air to an aerosol generating substrate, an air flow channeling assembly configured to deliver outside air into the chamber comprising a plurality of nonlinear air flow channels, wherein each air flow channel extends along a side wall of the chamber from an inlet opened toward the outside of the device to an outlet for discharging the delivered air to the chamber, and a heating unit configured to apply heat to the air flow channels.

### TECHNICAL FIELD

The present invention is generally directed towards an aerosol generating device. More specifically, the invention is directed towards an aerosol generating device comprising an air flow channeling assembly with non-linear air flow channels.

### BACKGROUND

Aerosol generating devices commonly employed for generating an aerosol from an aerosol generating substrate usually employ either conduction heating, convection heating or a combination of both. Furthermore, an aerosol generating device commonly comprises a chamber for receiving an aerosol generating substrate and a means for delivering air flow to the chamber. For heating both the chamber as well as the air delivered to the chamber, some configurations employ a heating unit for heating the chamber, and another heating unit for heating the means for delivering air, so that heated air is delivered to the chamber. However, since aerosol generating devices ideally need to be small enough to be hand-portable, the heating performance of aerosol generating devices for heating air delivered to the chamber is usually poor. This is because the residence time of air within the heated means for delivering air to the chamber is short since the size requirements lead to short travel distances of air within or through the heated means for delivering air and thus results in limited heat transfer to the air. Furthermore, employing two heating units makes the manufacture and design of the aerosol generating device more complicated and costly and further leads to increased size requirements of the device.

It is therefore an objective of the present invention to provide an aerosol generating device that allows air that is delivered to the chamber of the device to be effectively heated in a simple, space-saving and cost-efficient manner.

### SUMMARY OF THE INVENTION

The above objective is solved by the invention as defined by the features of the independent claims. Preferred embodiments of the invention are defined by the sub-features of the dependent claims.

In a first aspect, the invention provides an aerosol generating device comprising a chamber configured to receive and supply heated air to an aerosol generating substrate, an air flow channeling assembly configured to deliver outside air into the chamber comprising a plurality of nonlinear air flow channels, wherein each air flow channel extends along a side wall of the chamber from an inlet opened toward the outside of the device to an outlet for discharging the delivered air to the chamber, and a heating unit configured to apply heat to the air flow channels. A first advantage of this aspect is that by having air flow channels that are non-linear, the residence time of air inside the air flow channels is increased in comparison to linear air flow channels, resulting in increased heating of the air. As yet another advantage, by providing a plurality of air flow channels, the overall air flow rate can be increased without the need to enlarge an individual channel, and the heating performance or an air flow rate may, respectively, be easily adjusted by either increasing the non-linearity of the air flow channels or by changing the number of air flow channels. Finally, the plurality of air flow channels themselves can effectively be a layer of insulation, so that they remove heat travelling outward of the device, and less insulation may be required.

In a first preferred embodiment, according to the first aspect of the invention, the plurality of nonlinear air flow channels is formed by a plurality of tubes. Forming the air flow channels from tubes is cost efficient and allows the air flow channels to be easily formed and configured.

In a second preferred embodiment, according to the preceding embodiment of the invention, the plurality of tubes is arranged as an n-tuple helix, with the number n matching the number of tubes. Arranging the plurality of air flow channels in helical fashion in an n-tuple helix ensures homogenous properties for each of the tubes and affords a geometrically efficient arrangement of the plurality of tubes.

In a third preferred embodiment, according to the preceding embodiment of the invention, the n-tuple helix comprises at least two congruent helices.

In a fourth preferred embodiment, according to any one of the second or third preferred embodiment of the invention, the windings within each of the plurality of helices are evenly spaced apart in the direction of the winding axis of the n-tuple helix and/or the distance in the direction of the winding axis of the n-tuple helix between a winding of one of the helices and a neighboring winding of another of the helices is at most 2 mm, preferably at most 1 mm, more preferably at most 0.5 mm, and most preferably substantially o. Evenly spacing the helices apart provides homogeneous heating to the air flow channels and prevents thermal hotspots if, for example, a first helix is arranged too close to a second helix. Having only a very small distance between the neighboring windings of the different helices, or substantially no gap between the windings, provides a tight insulation layer with all the heat traveling outward picked up by the helices.

In a fifth preferred embodiment, according to any one of the preceding embodiments of the invention, the number of air flow channels is two. It has been found that having two non-linear air flow channels presents a balanced compromise between heating performance and air flow rate within the geometric constraints of typical aerosol generating devices.

In a sixth preferred embodiment, according to any one of the preceding embodiments of the invention, an outside wall of the aerosol generating device and/or the side wall of the chamber do not form part of the confining physical boundary of the air flow channel within the aerosol generating device. This reduces manufacturing complexity and increases manufacturing flexibility as the chamber and/or housing can be independently configured and manufactured from the air flow channels.

In a seventh preferred embodiment, according to any one of the preceding embodiments of the invention, the air flow channel is formed by a thermally conductive material. This is advantageous because a thermally conductive material better transfers heat from the heating unit to the air in the air flow channels, thus increasing the heating performance.

In an eighth preferred embodiment, according to the preceding embodiment of the invention, the thermally conductive material comprises material with a thermal conductivity equal or larger than 100

$$\frac{W}{m \cdot K} ,$$

preferably 150

$$\frac{W}{m \cdot K} ,$$

more preferably 200

$$\frac{W}{m \cdot K} ,$$

even more preferably 250

$$\frac{W}{m \cdot K} ,$$

even more preferably 300

$$\frac{W}{m \cdot K} ,$$

even more preferably 350

$$\frac{W}{m \cdot K} ,$$

most preferably larger than 400

$$\frac{W}{m \cdot K} , .$$

thermal conductivity, the better the heating performance.

In a ninth preferred embodiment, according to any one of the seventh or eighth preferred embodiment of the invention, the thermally conductive material is or comprises copper, aluminum, copper-nickel, stainless steel, Hastelloy, Inconel and/or titanium. These materials are advantageous because they are thermally conductive as well as durable and suitable for being heated.

In a tenth preferred embodiment, according to any one of the preceding embodiments of the invention, the aerosol generating device comprises a heating unit configured to heat the side wall of the chamber, the heating unit configured to heat the side wall of the chamber preferably being the heating unit configured to apply heat to the air flow channels. By heating the side wall of the chamber, in additional to air, an aerosol generating substrate at least partially received in the chamber may also be heated for generating aerosol. By combining the heating units into a single heating unit, manufacturing costs and complexity as well as the overall size of the aerosol generating device may be reduced.

In an eleventh preferred embodiment, according to the preceding embodiment of the invention, the heating unit configured to heat the side wall is disposed on at least parts of the side wall of the chamber.

In a twelfth preferred embodiment, according to the preceding embodiment of the invention, the heating unit configured to heat the side wall is disposed between the side wall of the chamber and the plurality of air flow channels. This is advantageous because it allows both the chamber and the air flow channels to be more homogeneously heated and to be heated at the same time.

In a thirteenth preferred embodiment, according to any one of the tenth to the twelfth preferred embodiment of the invention, the plurality of air flow channels is arranged to at least partially adjoin the heating unit configured to heat the side wall and/or the heating unit configured to apply heat to the air flow channels. Such a configuration increases the heat transfer between the heating unit and the air flow channels, thus improving the heating performance.

In a fourteenth preferred embodiment, according to any one of the tenth to the thirteenth preferred embodiment of the invention, the heating unit configured to heat the side wall and/or the heating unit configured to apply heat to the air flow channels is or comprises a film heater. A film heater is advantageous because it can conform to the sidewall of the chamber, thus ensuring improved heating efficiency and performance. Furthermore, a film heater may be provided with minimal space requirements.

In a fifteenth preferred embodiment, according to the preceding embodiment of the invention, the film heater comprises a resin, the resin comprising polyimide, silicone and/or PEEK.

In a sixteenth preferred embodiment, according to the preceding embodiment of the invention, the chamber has a substantially cylindrical shape comprising an opening configured to allow the aerosol generating substrate to be at least partially or fully inserted into the chamber.

In a seventeenth preferred embodiment, according to any one of the preceding embodiments of the invention, the positions of the air inlets and/or air outlets of the plurality of air flow channels are, respectively, in the same plane, substantially perpendicular to the central axis of the chamber.

In an eighteenth preferred embodiment, according to any one of the preceding embodiments of the invention, the air inlets and/or air outlets of the plurality of air flow channels are, respectively, arranged with a difference of substantially 360° divided by the number n of air flow channels, in a rotation angle around the central axis of the chamber to each other.

In a nineteenth preferred embodiment, according to any one of the preceding embodiments, the chamber comprises an opening at the bottom of the chamber that is in communication with each of the plurality of air outlets.

In a twentieth preferred embodiment, according to any one of the preceding embodiments of the invention, the aerosol generating device comprises a diffusing element arranged at the air outlets such that air exiting the air outlets passes through the diffuser. The diffusing element is advantageous because by diffusing heated air discharged from the air outlets, the heated air is spatially distributed, resulting in a more homogeneous heating of the chamber and/or of any aerosol generating substrate at least partially received in the chamber.

In a twenty-first preferred embodiment, according to the preceding embodiment of the invention, the diffusing element comprises a porous material. This is advantageous because a porous material is effective in diffusing air.

In a twenty-second preferred embodiment, according to the preceding embodiment of the invention, the porous material comprises porous ceramic, porous resin, porous glass and/or porous metal.

In a twenty-third preferred embodiment, according to any one of the preceding embodiments of the invention, the aerosol generating device comprises a heat insulating member configured to at least partially surround the airflow channeling assembly. The insulating member improves thermal insulation of the aerosol generating device, in particular with regards to the heat emitted from the heating unit and serves to reduce heat transfer to the outside of the aerosol generating device or to a user using the aerosol generating device.

In a twenty-fourth preferred embodiment, according to the preceding embodiment of the invention, the heat insulating member has a cylindrical shape and is substantially concentric with the chamber.

In a twenty-fifth preferred embodiment, according to any one of the twenty-third or twenty-fourth preferred embodiment of the invention, the air flow channeling assembly is at least partially embedded in the heat insulating member.

In a twenty-sixth preferred embodiment, according to any one of the preceding embodiments of the invention, the total inner volume of the one or more heat conductive tubes is in a range of 55±25 ml, more preferably 55±20 ml, even more preferably 55±15 ml, even more preferably 55±10 ml, even more preferably 55±5 ml, and most preferably 55±1 ml. Having a volume in a range around 55 ml is advantageous because a single aerosol puff on average contains a volume of about 55 ml. This allows almost all of the air inhaled during one puff to be heated.

In a twenty-seventh preferred embodiment, according to any one of the preceding embodiments of the invention, at least 50%, preferably 60%, more preferably 70%, even more preferably 80%, even more preferably 90%, most preferably 100% of the length of the non-linear air flow channels extends along the side wall. This is advantageous because the larger the portion of the length of the non-linear air flow channel that extends along the length of the chamber, the more optimised the use of space inside the aerosol generating device for accommodating the plurality of non-linear air flow channels. As an additional result, the thermal insulation of the heating chamber to the outside of the aerosol generating device by the non-linear air flow channels is increased.

### BRIEF DESCRIPTION OF THE DRAWINGS

FIG. 1 illustrates a schematic cross-sectional view of an aerosol generating device according to embodiments of the present invention;

FIG. 2A, 2B and 2C illustrate a schematic perspective view, side view and top view, respectively, of a chamber with a heating unit and non-linear air flow channels of an aerosol generating device according to embodiments of the present invention.

### DETAILED DESCRIPTION OF PREFERRED EMBODIMENTS

Preferred embodiments of the present invention are described hereinafter and in conjunction with the accompanying drawings.

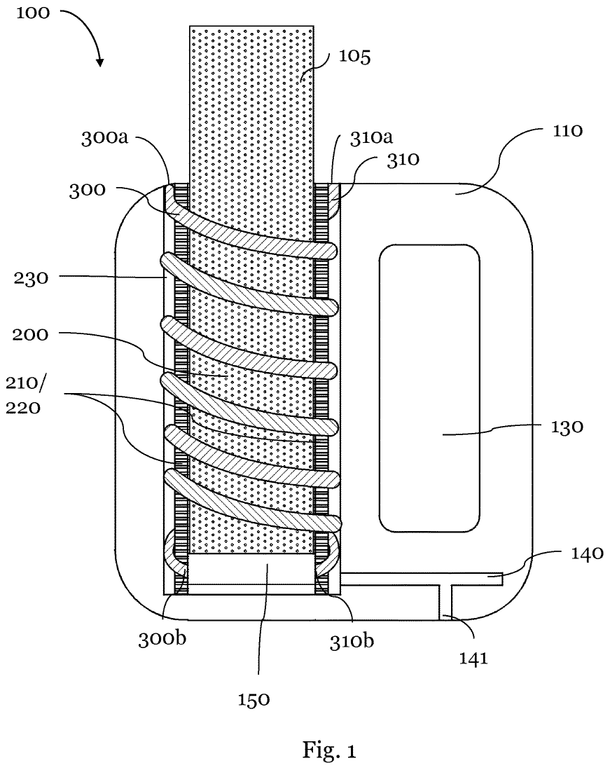

As illustrated in FIG. 1, an aerosol generating device 100 comprises a housing 110. The housing 110 is configured such that it may accommodate a chamber 200 that is capable of at least partially receiving an aerosol generating substrate 105 for generating an aerosol in the chamber 120. The chamber 120 is open to one side of the aerosol generating device 100 such that the aerosol generating substrate 105 may be at least partially be inserted into the chamber 120. The aerosol generating substrate 105 may be any substrate suitable for an aerosol based on an e-vapor or t-vapor. The aerosol generating substrate 105 may include a tobacco material in various forms such as shredded tobacco and granulated tobacco, and/or the tobacco material may include tobacco leaf and/or reconstituted tobacco if it is suitable for a t-vapor.

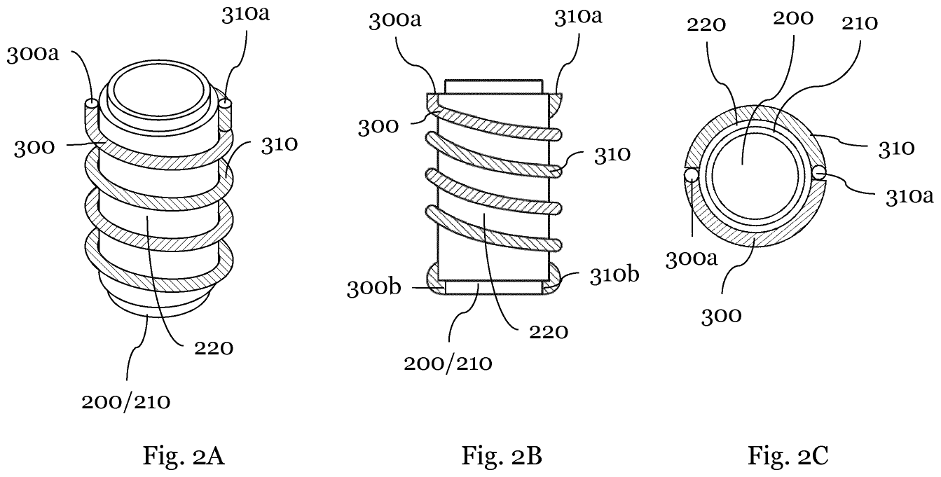

The chamber 200 may be configured such that a sidewall 210 of the chamber is spaced apart from a corresponding sidewall of the housing 110 such that a sufficient space 230 is formed. While the chamber 200 is shown in FIGS. 2A to 2C to have a substantially cylindrical base, the base may be of any appropriate shape such as of a rectangular, elliptic, polygonal or irregular shape.

Within the space 230, a first non-linear air flow channel 300 and a second non-linear air flow channel 310 may be provided. The first non-linear air flow channel 300 may extend along a side wall of the chamber from air inlet 300a, opened to an outside of the aerosol generating device, to air outlet 300b, opened towards the chamber 200. The second non-linear air flow channel 310 may extend along a side wall of the chamber from air inlet 310a, opened towards an outside of the aerosol generating device 100, to air outlet 310b for discharging air to the chamber 200. While it is ideally preferable that the entire length of the first air flow channel 300 and/or the second air flow channel 310 extends along the side wall of the chamber, depending on the spatial configuration and varying space requirements inside an aerosol generating device, this may not always be possible. To reduce the spatial requirements of the non-linear air flow channels and to increase any thermal insulating properties of the non-linear air flow channels 300, 310 for providing thermal insulation of the heating chamber 120 to the outside of the aerosol generating device 100, it is preferred that at least 50%, preferably 60%, more preferably 70%, even more preferably 80%, even more preferably 90%, most preferably 100% of the length of the non-linear air flow channels 300, 310 extends along the side wall of the heating chamber 120.

The air inlet 300a of the first non-linear airflow channel 300 and the air inlet 310a of the second non-linear air flow channel may be positioned at the same height, meaning in the same plane that is perpendicular to the central axis of the chamber 200, or at different heights, meaning in different parallel planes that are perpendicular to the central axis of the chamber 200. Furthermore, the air outlet 300b of the first non-linear airflow channel 300 and the air outlet 310b of the second non-linear air flow channel may be positioned at the same height, meaning in the same plane that is perpendicular to the central axis of the chamber 200, or at different heights, meaning in different parallel planes that are perpendicular to the central axis of the chamber 200. While the air inlets 300a and 310a are illustrated to be positioned with an angle of substantially 180° in rotation around the central axis of the chamber 200 to each other, they may be positioned with any suitable rotation angle to each other. Furthermore, while the air outlets 300b and 310b are illustrated to be positioned with an angle of substantially 180° in rotation around the central axis of the chamber 200 to each other, they may be positioned with any suitable rotation angle to each other.

The first non-linear air flow channel 300 and/or the second non-linear air flow channel 310 may be formed by a first and second tube, that may be formed as a first helix and a second helix. Furthermore, the first helix and the second helix may be congruent to each other. The first helix and the second helix may be arranged in a double helix. The winding axis of the double helix should be substantially parallel to the central axis of the chamber 200 extending in the direction of the length of the chamber 200.

Furthermore, the windings of each of the first and second helix may be evenly spaced apart in the direction of the winding axis of the helix. Preferably, the distance in the direction of the winding axis of the n-tuple helix between a winding of one of the helices and a neighboring winding of another of the helices is at most 2 mm, preferably at most 1 mm, more preferably at most 0.5 mm, and most preferably substantially o (not shown in the figures).

The first air flow channel 300 and/or the second air flow channel 310 may be formed from a thermally conductive material. Thermally conductive means that the material or combination of materials may have a thermal conductivity equal to or larger than 100

$$\frac{W}{m \cdot K} ,$$

preferably 150

$$\frac{W}{m \cdot K} ,$$

more preferably 200

$$\frac{W}{m \cdot K} ,$$

even more preferably 250

$$\frac{W}{m \cdot K} ,$$

even more preferably 300

$$\frac{W}{m \cdot K} ,$$

even more preferably 350

$$\frac{W}{m \cdot K} ,$$

most preferably 400

$$\frac{W}{m \cdot K} , .$$

The thermally conductive material may be or may comprise copper, aluminum, copper-nickel, stainless steel, Hastelloy, Inconel, titanium and/or any suitable heat exchanger material.

In a space 230 provided between the chamber sidewall 210 and the housing 110 sidewall, a heating unit 220 configured to heat the first and second non-linear air flow channels 300 and 310 may be provided. Furthermore, an additional heating unit configured to heat the chamber 200 may be provided. While the heating unit configured to heat the chamber 200 and the heating unit configured to heat the first and second non-linear air flow channels 300 and 310 may be distinct heating units separate from each other, the heating unit configured to heat the chamber 200 may also be configured to heat the first and second non-linear airflow channels 300 and 310. For achieving this, the heating unit 220 may be provided along the sidewall 210 of the chamber 200. The heating unit 220 may be provided on at least parts of the inner surface of the sidewall 210 and/or on at least parts of the outer surface of the sidewall 210 of the chamber 200. When provided on at least parts of the outer surface of the sidewall 210 of the chamber 200, the heating unit 220 is provided between the sidewall 210 of the chamber and the first and second non-linear air flow channels 300 and 310 such that the first and second non-linear air flow channels 300 and 310 may adjoin the heating unit 220. Furthermore, the heating unit may comprise one or more film heaters provided on at least parts of the sidewall 210. The one or more film heaters may comprise a resin that comprises polyimide, silicone and/or PEEK. Additionally, or alternatively, the heating unit 220 may comprise one or more heating tapes or heating wires provided on at least parts of the sidewall 210. The heating tapes and/or heating wires may be provided on at least parts of the sidewall 210 such that a position of the heating tapes and/or heating wires corresponds to the position of the windings of the first and/or second non-linear air flow channels 300 and/or 310.

The space 230 may be provided with an insulating member (not shown). The insulating member may cover at least parts or all of the inner surface of the housing and surround the non-linear air flow channels 300 and 310 as well as the chamber 200 in axial directions with respect to the central axis of the chamber 200. Additionally, or alternatively, the insulating member may also be provided such that the first and second non-linear air flow channels are at least partially embedded within the insulating material. Furthermore, when embedding the first and second non-linear air flow channels 300 and 310 in the insulating material, the insulating member may take up the entire space 230 between the chamber sidewall 210 and the sidewall of the housing 110.

The aerosol generating device 100 may further be provided with a diffusing element 150 located at the air outlets 300b and 310b. Depending on the configuration of the chamber 200 and the housing 110, the air diffusing element 150 may be provided in the chamber 200 at the bottom of the chamber, and the air outlet 300b and 310b are opened towards the diffusing element 150 such that any air discharged from the air outlet 300b and 310b passes through the diffusing element. The bottom of the chamber is typically opposite the opening of the chamber that is configured to allow the aerosol generating substrate to be at least partially or fully inserted into the chamber. Additionally, or alternatively, the chamber 200 may be provided with a bottom opening. The diffusing element 150 may then be positioned in the bottom opening or upstream of the bottom opening in an air flow direction. Air outlets 300b and 310b are then positioned such that any air discharged from the air outlet 300b and 310b passes the diffusing element 150 before reaching the bottom opening and entering the chamber 200. The diffusing element may in general comprise any porous material that is suitable with regard to thermal stability and air ventilation properties of the material.

The aerosol generating device 100 may further comprise a mobile power source 130 such as a battery, for supplying power to the aerosol generating device for generating an aerosol. Furthermore, control circuitry 140 may be provided for controlling any function for operating and/or controlling the aerosol generating device loft A charging port 141 may be provided for allowing the mobile power source 130 to be charged by any suitable means. Additionally, or alternatively, the mobile power source 130 may be exchangeable/replaceable.

As illustrated in FIGS. 2A, 2B and 2C, the chamber 200 may be provided with a heating unit 220 that covers at least parts of the outer surface of the sidewall 210 of chamber 200. The chamber 200 may be a chamber as described above in the context of FIG. 1.

The chamber 200 may have different base shapes. The heating unit 220 may be a heating unit as described above in the context of FIG. 1. For example, the heating unit 220 may comprise one or more film heaters and/or heating tapes and be provided on the outer surface and/or the inner surface of the chamber sidewall 210. A first helical tube 300 and a second helical tube 310 are arranged in a double helix. The air inlet 300a of the first helical tube 300 and the air inlet 310a of the second helical tube 310 may be provided at the same height, meaning in the same plane perpendicular to the winding axis and central axis of the chamber 200. The first and second helical tubes 300 and 310 may be formed as described for the first and second non-linear air flow channels in the context of FIG. 1. For example, the first and second helical tube 300 and 310 may be formed of a thermally conductive material. The double helix comprising the first and second helical tube 300 and 310 may be wound around the heating unit 220 that is provided on at least parts of the sidewall 210 such that the heating unit 220 is disposed between the first and second helical tubes 300 and 310 and the outer surface of the sidewall 210 of the chamber 200.

It will be apparent to the skilled person that, while the number of air flow channels as shown in any of the FIGS. 1, 2A, 2B and 2C is two, in any embodiment of the present invention, any suitable plurality of air flow channels may be provided, for example three, four, or five air flow channels. If the number n matches the number of non-linear air flow channels, the air inlets and/or air outlets of the plurality of non-linear air flow channels may be positioned with an angle of for example 360°/n between each position instead of an angle of 180° as described in the context of any one of the FIGS. 1, 2A, 2B and 2C. Each of the plurality of air flow channels may be an air flow channel as described for the first air flow channel 300 and/or the second air flow channel 310 in the context of any one of the FIGS. 1, 2A, 2B and 2C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the scope of this disclosure, as defined by the independent and dependent claims.

### LIST OF REFERENCE SIGNS USED IN THE DRAWINGS

100: aerosol generating device
105: aerosol generating substrate
110: housing
120: chamber
130: power supply
140: PCB/control circuit
141: charging port
150: diffusing element
200: chamber
210: chamber wall
220: heating unit
230: space
300/310: air flow channel
300a/310a: air inlet
300b/310b: air outlet

1. An aerosol generating device, comprising:
a chamber configured to receive and supply heated air to an aerosol generating substrate;
an air flow channeling assembly configured to deliver outside air into the chamber, comprising a plurality of nonlinear air flow channels, wherein each air flow channel extends along a side wall of the chamber from an inlet opened toward the outside of the device to an outlet for discharging the delivered air to the chamber; and
a heating unit configured to apply heat to the air flow channels.

2. The aerosol generating device according to claim 1, wherein the plurality of nonlinear air flow channels is formed by a plurality of tubes.

3. The aerosol generating device according to claim 2, wherein the plurality of tubes is arranged as an n-tuple helix, with the number n matches the number of tubes.

4. The aerosol generating device according to claim 3, wherein the n-tuple helix comprises at least two congruent helices.

5. The aerosol generating device according to claim 3, wherein windings of each of the plurality of helices are evenly spaced apart in a direction of a winding axis of the n-tuple helix and/or a distance in the direction of the winding axis of the n-tuple helix between a winding of one of the helices and a neighboring winding of another of the helices is at most 2 mm.

6. The aerosol generating device according to claim 1, wherein an outside wall of the aerosol generating device and/or the side wall of the chamber do not form part of the confining physical boundary of the air flow channel within the aerosol generating device.

7. The aerosol generating device according to claim 1, wherein the air flow channel is formed by a thermally conductive material.

8. The aerosol generating device according to claim 7, wherein the thermally conductive material comprises material with a thermal conductivity equal or larger than
$$100 \frac{W}{m \cdot K} .$$

9. The aerosol generating device according to claim 1, wherein the heating unit is additionally configured to heat the side wall of the chamber.

10. The aerosol generating device according to claim 9, wherein the heating unit.

11. The aerosol generating device according to claim 1, wherein a position of the air inlets and/or air outlets of the plurality of air flow channels are provided, respectively, in a plane perpendicular to a central axis of the chamber.

12. The aerosol generating device according to claim 1, wherein the chamber comprises an opening at the bottom of the chamber that is opposite another opening of the chamber that is configured to allow the aerosol generating substrate to be at least partially or fully inserted into the chamber, the bottom of the chamber being in communication with each of the plurality of air outlets.

13. The aerosol generating device according to claim 1, comprising a diffuser element arranged at the air outlets such that air exiting the air outlets passes through the diffuser.

14. The aerosol generating device according to claim 13, wherein the diffuser element comprises a porous material.

15. The aerosol generating device according to claim 1, wherein at least 50% of the length of the non-linear air flow channels extends along the side wall.

16. The aerosol generating device according to claim 5, wherein distance in the direction of the winding axis of the n-tuple helix between a winding of one of the helices and a neighboring winding of another of the helices is at most 0.5 mm.

17. The aerosol generating device according to claim 15, wherein an entire length of the non-linear air flow channels extends along the side wall.
